(19) United States
(12) Patent Application Publication
(10) Pub. No.: US 2002/0192065 A1
(43) Pub. Date: Dec. 19, 2002

(54) Quick attach grapple apparatus

(76) Inventor: Mark Underwood, Burr Oak, KS (US)

Correspondence Address: Hovey, Williams, Timmons & Collins, Mark Underwood, 2405 Grand, Suite 400, Kansas City, MI, 64108, US

(21) Appl. No.: 09/881,082

(22) Filed: Jun. 13, 2001

(51) Int. Cl. B66C 1/00

(52) U.S. Cl. 414/729

(57) ABSTRACT

A grapple (10) for use with a loader (26) and a loader attachment (55) includes a base frame (11) and a pair of swingable arms (12, 13) supporting a grapple tooth assembly (14). A first coupling assembly (22, 23) configured for coupling with the loader (26) is provided on a rear side of the base frame (1). A second coupling assembly (29, 30) configured for coupling with the loader attachment (55) is provided on a front side (31) of the base frame (11). The second coupling assembly (29, 30) corresponds in size and shape to the first coupling assembly (22, 23) such that the grapple (10) can be interposed between the loader (26) and any loader attachment (55) capable of coupling to the loader (26). The grapple tooth assembly (14) is pivotally coupled to the swingable arms (12, 13) using resilient bushings (78, 79) that allow the grapple (10) to twist and conform to uneven loads.

### BACKGROUND OF THE INVENTION

1. Field of the Invention

The present invention relates generally to attachments for loaders. In particular, the present invention relates to a grapple that can be used in combination with other loader attachments, and a quick attach assembly for connecting the grapple to a loader.

2. Description of the Related Art

Front end loaders are generally known in the art for use in performing a wide range of grading, digging, construction, brush clearing, lifting, and other related tasks. A front end loader typically comprises a tractor-type vehicle equipped with a pivoting frame having a selected work attachment, such as a scoop, bucket, manure fork, bale fork, tree saw, and the like, connected thereto. Hydraulic actuators are provided on the vehicle for controlled raising and lowering of the pivoting frame, and controlled fore-aft pitch adjustment of the work attachment. Appropriate manipulation of the hydraulic actuators enables the work attachment to be manipulated to perform a desired task.

Grapples are often used in combination with another work attachment, such as a bucket or manure fork. For example, grapples are sometimes bolted or pinned to a structure mounted to a loader bucket so that the mounted grapple can be used together with the bucket for handling loads, such as large round bales or forage. If an operator desires to remove the grapple from the bucket for use with another loader attachment or to use the bucket by itself, the grapple generally must be disassembled from the bucket, which can be difficult and time consuming.

A grapple having a quick attachment structure for use with a loader bucket has been disclosed in U.S. Pat. No. 5,639,205. The grapple fork in the '205 patent requires a modification to the existing boom arms of a loader before it can be attached to the loader. This prevents the quick attachment structure from being usable with most existing loaders until expensive and time-consuming modifications are first made to the loaders.

There is a need in the industry for an improved grapple apparatus that can be attached to existing loaders and used with various loader attachments.

### SUMMARY OF THE INVENTION

It is an object of the present invention to provide an improved grapple which can be attached and detached from a conventional loader quickly and easily without modifying the existing boom arms of the loader.

It is a further object of the present invention to provide a grapple that can be attached to a loader and used with a wide variety of other loader attachments.

It is a further object of the present invention to provide a grapple having an improved construction that allows the tines of the grapple to conform to an irregular-shaped load.

It is a further object of the present invention to provide an improved quick attach coupling assembly that can be used efficiently with loaders and loader attachments, and that is economical to manufacture, capable of a long operating life, and particularly well suited for coupling a grapple or other implement to a loader for use with other loader attachments.

In order to solve the problems with the prior art described above, the applicant has developed an improved grapple for mounting to a loader. The grapple includes a base frame and a pair of swingable arms supporting a grapple tooth assembly. A first coupling assembly configured for coupling with the loader is provided on a rear side of the base frame. A second coupling assembly configured for coupling with the loader attachment is provided on a front side of the base frame. The second coupling assembly corresponds in size and shape to the first coupling assembly such that the grapple can be interposed between the loader and any loader attachment capable of coupling to the loader. The grapple tooth assembly is pivotally coupled to the swingable arms using resilient bushings that allow the grapple to twist and conform to uneven loads.

According to a broad aspect of the present invention, a grapple for use with a loader and a loader attachment is provided, comprising: a base frame having a front side and a rear side; at least one swingable arm having a first end pivotally connected to the base frame and a second end supporting a grapple tooth assembly; and a hydraulic actuator connected between the base frame and the grapple arm to swing the grapple arm relative to the base frame; the base frame having a first coupling assembly on the rear side and a second coupling assembly on the front side, the first coupling assembly being configured for coupling with the loader, and the second coupling assembly being configured for coupling with the loader attachment.

According to another broad aspect of the present invention, a combination of a loader, a first loader attachment, and a second loader attachment are provided, the first and second loader attachments each having a coupling assembly configured for attaching to a corresponding structure on the loader such that the first and second loader attachments are interchangeable. The first loader attachment further comprises: a base frame having a front side and a rear side; at least one swingable arm having a first end pivotally connected to the base frame and a second end supporting a tool; and a hydraulic actuator connected between the base frame and the swingable arm to swing the swingable arm relative to the base frame; the base frame having a first coupling assembly on the rear side and a second coupling assembly on the front side, the first coupling assembly being configured to couple with the corresponding structure on the loader, and the second coupling assembly being configured to couple with the coupling assembly of the second loader attachment, whereby the second loader attachment can be coupled to and used with the first loader attachment after the first loader attachment is coupled to the loader.

According to yet another broad aspect of the present invention, a loader attachment for use with a loader is provided, comprising: a base frame; a pair of swingable arms each having a first end pivotally connected to the base frame about a transverse axis, and a second end; and a tool having right and left sides which are connected to the respective second ends of the swingable arms; the right and left sides of the tool being pivotally coupled to the second ends of the swingable arms using resilient bushings that allow the tool and swingable arms to twist and conform to uneven loads.

Numerous other objects of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a grapple having a quick attach coupling assembly and structure according to the present invention.

FIG. 2 is a side view of the grapple of the present invention coupled between a loader and a loader bucket.

FIG. 3 is a cutaway front view of the grapple showing the locking pin assemblies used to lock a loader attachment to the front side of the grapple.

FIG. 4 is a partial plan view of one of the locking pin assemblies showing details of the actuating lever.

FIG. 5 is a side view of a swing arm of the grapple having an adjustable length.

FIG. 6 is a cross sectional side view of the grapple.

FIGS. 7 and 8 are front views of the grapple tooth assemblies showing a twisting motion that allows the grapple to conform to uneven loads.

FIG. 9 is a rear view of the grapple.

FIG. 10 is an enlarged perspective view of one of the locking pin assemblies.

### DETAILED DESCRIPTION OF THE PREFERRED EMBODIMENT

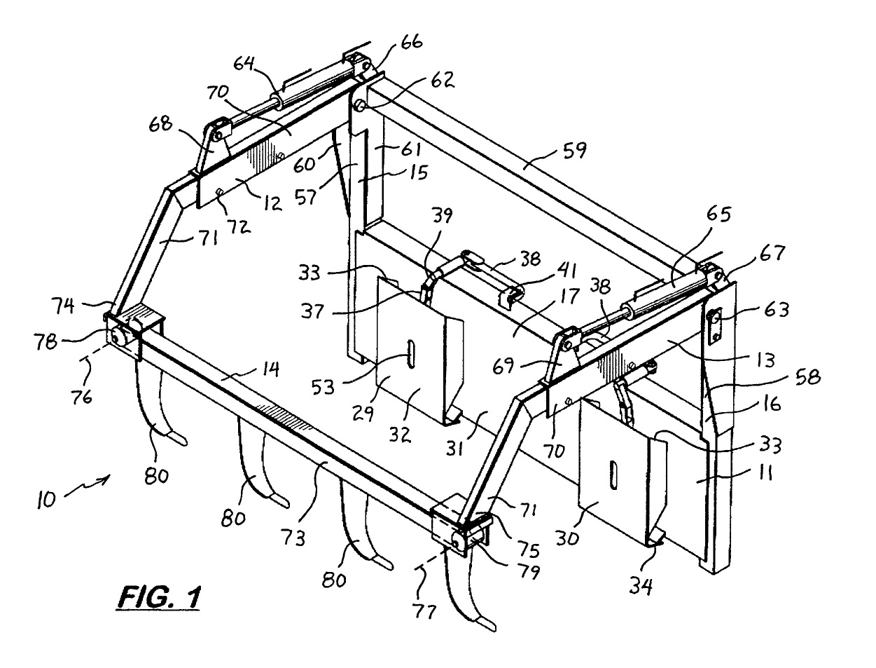

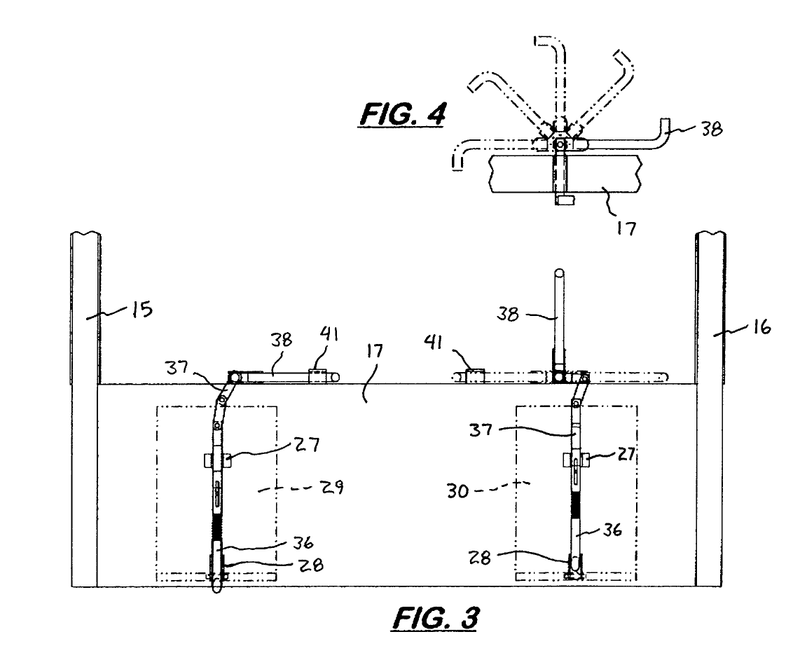

A quick attach grapple assembly for a loader according to a preferred embodiment of the present invention will now be described with reference to FIGS. 1 to 10 of the accompanying drawings.

The grapple 10 of the present invention includes a base frame 11, a pair of swingable arms 12, 13, and a grapple tooth assembly 14. The base frame 11 comprises a generally rectangular structure having first and second upstanding side members 15, 16, and a plate member 17 extending between the side members.

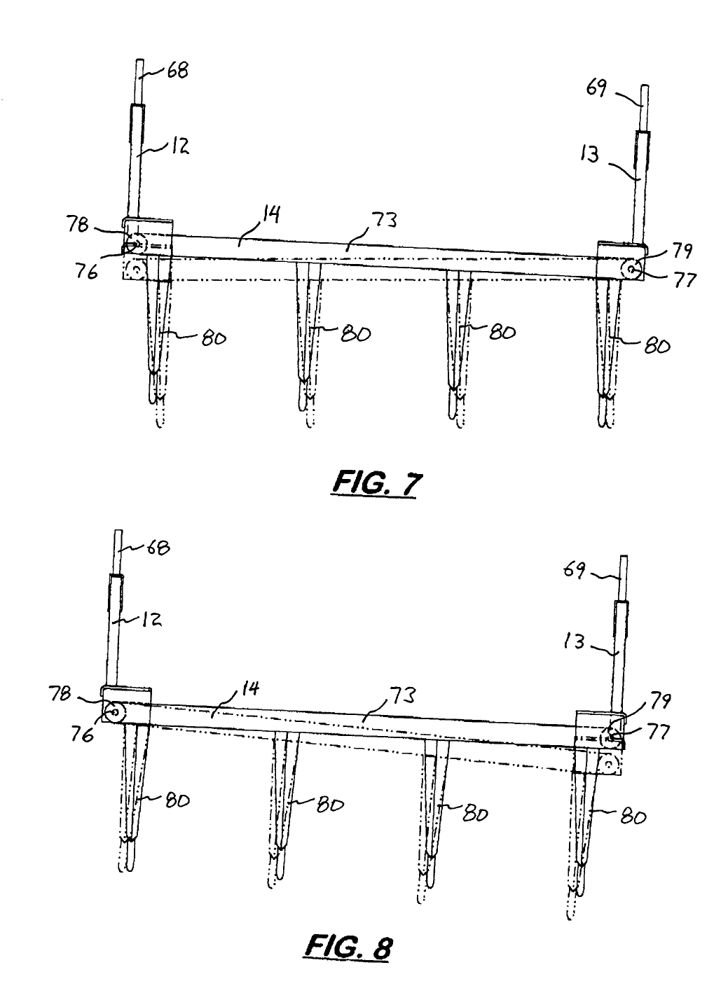

The plate member 17 has a cross-section configuration as shown in FIG. 6. Specifically, the plate member 17 has a vertical main portion 18, a first horizontal portion 19 extending rearwardly from a top of the vertical main portion 18, a vertical rear portion 20 extending downwardly from a rear of the first horizontal portion 19, a second horizontal portion 21 extending forwardly from a bottom of the rear portion 20, and an angled mounting portion 22 extending at an angle upwardly and forwardly from a front of the second horizontal portion 21 to a rear face of the vertical main portion 18. The plate member 17 has near its bottom end an angled bottom portion 23 extending downwardly and rearwardly from a bottom of the vertical main portion 18. The angled bottom portion 23 has first and second openings 24, 25 (FIG. 9) formed therein for receiving right and left locking pin assemblies of a loader 26. The angled mounting portion 22 and the angled bottom portion 23 provide a first coupling assembly on the rear side of the base frame 11.

A second coupling assembly is provided on the front side of the base frame 11. The second coupling assembly includes right and left coupling assemblies 29, 30 secured to a front side 31 of the plate member 17. The coupling assemblies 29, 30 each have a front surface 32, a sloped upper engagement surface 33 which extends upwardly and forwardly from the front side 31 of the plate member 17 to the front surface 32, and a lower engagement surface 34. The upper engagement surface 33 is defined by the upper edge of a folded plate structure, as shown in FIGS. 1 and 6. Alternatively, the upper engagement surface can be a flat plate member that extends across the upper end of each coupling assembly 29, 30. The lower engagement surface 34 of each coupling assembly 29, 30 extends rearwardly and downwardly from the front surface 32 thereof. An opening 35 is formed through each of the lower engagement surfaces 34 through which a locking pin 36 can be moved.

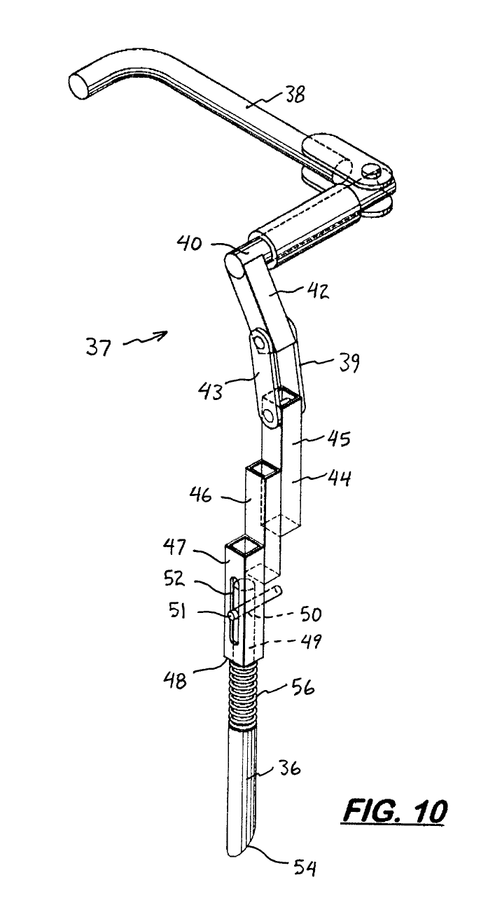

The right and left coupling assemblies 29, 30 each have a locking pin assembly 37. As shown in FIG. 10, the locking pin assemblies 37 each have a handle 38 positioned on an upper side of the plate member 17, the locking pin 36, and a mechanical linkage 39 connecting the handle 38 to the locking pin 36. The mechanical linkage 39 includes a first shaft 40 pivotally mounted to the plate member 17 for rotation about a longitudinal axis. The handle 38 is pivotally connected to a first end of the first shaft 40 and rotatable about an axis perpendicular to the longitudinal axis of the first shaft 40. A holder 41 (FIG. 1) is secured to the upper side of the plate member 17 into which the handle 38 can be placed to restrict movement of the handle 38. The handle 38 provides a manual actuating lever for moving the locking pin assembly 37.

A throw arm 42 is fixed to and extends from a second end of the first shaft 40. A first link 43 is pivotally connected between a free end of the throw arm 42 and an upper end of an offset link 44. The offset link 44 is formed of a plurality of tubular members including an upper member 45, an intermediate member 46, and a lower member 47. The lower member 47 has an open lower end 48 through which an upper portion 49 of the locking pin 36 is slidably received. The locking pin 36 has an opening 50 through its upper portion 49 for receiving a roll pin 51. The lower member 47 of the offset link 44 includes a slotted opening 52 on its front and back sides to accommodate the ends of the roll pin 51 inserted through the opening 50 of the locking pin 36. A slotted opening 53 is also formed in the front surface 32 of the coupling assembly 29, 30 to accommodate a front end of the roll pin 51 and provide access to the mechanical linkage 39.

The roll pin 51 functions to prevent rotation of the locking pin 36 about its longitudinal axis, and to provide a stop limit for sliding movement of the locking pin 36 within the lower member 47 of the offset link 44. The bottom end 54 of the locking pin 36 is tapered to facilitate coupling with a loader attachment, such as a loader bucket 55. The locking pin assembly 37 is guided for reciprocating movement in a vertical direction by a pair of guide members 27 positioned on each side of the offset link 44, and by a tubular guide 28 through which the locking pin 36 is inserted.

The locking pins 36 of the locking pin assemblies 37 are each movable between a locked position (shown on the left-hand side of FIG. 3) in which the locking pin 36 protrudes from the lower engagement surface 34, and an unlocked position (shown on the right-hand side of FIG. 3) in which the pin 36 does not protrude therefrom. A compression spring 56 is arranged about a mid portion of the locking pin 36 to bias the locking pin 36 into its locked position. The spring 56 and the tapered bottom end 54 of the locking pin 36 cooperate to provide a quick attach function when the coupling assemblies 29, 30 are moved into engagement with a corresponding structure on the loader attachment 55. When the loader attachment 55 is pushed into engagement with the tapered bottom end 54 of the locking pin 36, the locking pin 36 is moved upwardly against the bias of the spring 56 until the loader attachment 55 is completely seated against the coupling assemblies 29, 30. At this point, the locking pin 36 is positioned over a corresponding opening in the loader attachment 55, and the spring 54 pushes the locking pin 36 downwardly into locking engagement with the loader attachment 55. The coupling assemblies 29, 30 preferably correspond in size and shape to the standard quick attach coupling assemblies normally found on the loader 26.

The first and second upstanding side members 15, 16 have upper portions 57, 58 that protrude above the top of the plate member 17. A cross member 59 extends between the top ends of the side members 15, 16 to stabilize the base frame 11. The side members 15, 16 are sandwiched between reinforcement plates 60, 61 which are secured to each side of the side members 15, 16 to reinforce the side members and to provide respective pivot points 62, 63 for the swingable arms 12, 13.

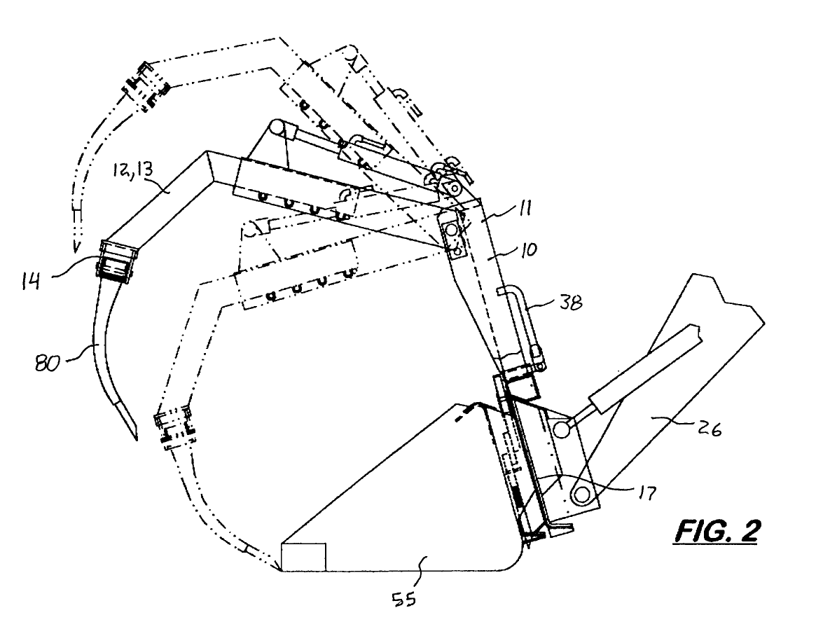

The swingable arms 12, 13 are pivotally mounted to right and left sides of the base frame 11 at the pivot points 62, 63 provided by the reinforcement plates 60, 61 near the top ends of the side members 15, 16. The pivot points 62, 63 allow the swingable arms 12, 13 to rotate about respective transverse axes. The swingable arms 12, 13 are movable relative to the base frame 11 about the pivot points 62, 63 by respective hydraulic actuators 64, 65. The hydraulic actuators 64, 65 are connected between first flanges 66, 67 protruding from the top ends of the side members 15, 16, and second flanges 68, 69 protruding from upper sides of the swingable arms 12, 13. The hydraulic actuators 64, 65 are operable to move the swingable arms 12, 13 through approximately 90 degrees of movement, as shown in FIG. 2.

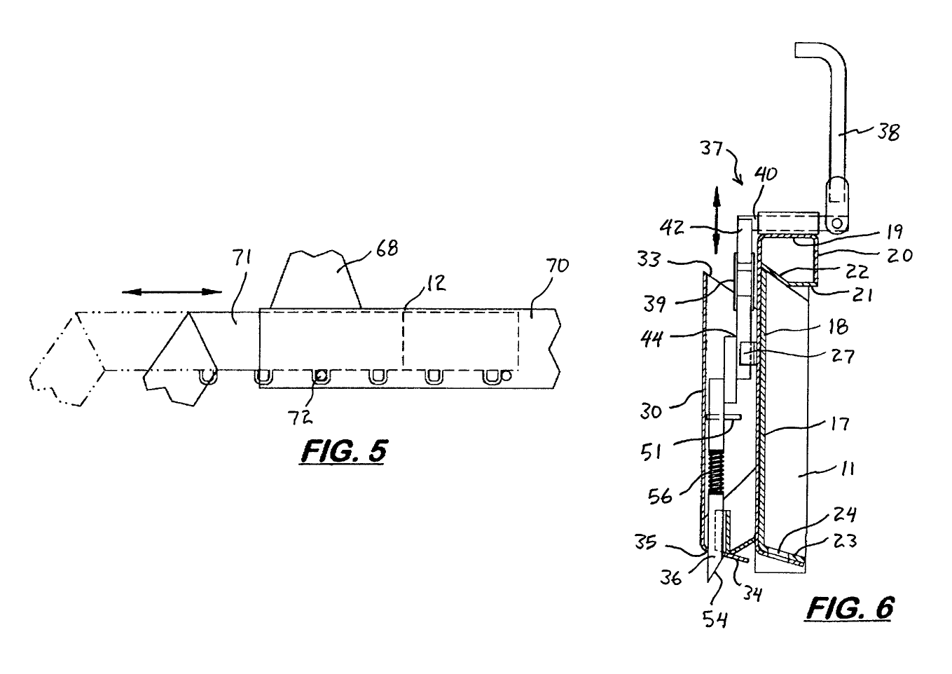

The swingable arms 12, 13 are adjustable in length by a telescoping arrangement shown in FIG. 5. The swingable arms 12, 13 each have an outer portion 70 on which the second flanges 68, 69 are mounted for connecting the hydraulic actuators 64, 65, and an inner portion 71 which is slidably received within the outer portion 70. A pair of pins or bolts 72 are inserted through respective openings in the inner and outer portions of the swingable arms 12, 13 to lock the arms in a selected length. The inner portion 71 of the swingable arms 12, 13 are movable in a telescoping manner within the outer portions 70 to change the length of the arms 12, 13. The distinct positions of the openings in the inner portions 71 of the arms 12, 13 facilitate uniform adjustment of the arms to selected lengths.

The grapple tooth assembly 14 includes a cross bar 73 that extends between the free ends 74, 75 of the swingable arms 12, 13. The right and left sides of the cross bar 73 are pivotally coupled to the swingable arms 12, 13 about respective longitudinal axes 76, 77. The longitudinal axes 76, 77 are generally perpendicular to the transverse axes of the pivot points 62, 63 about which the swingable arms 12, 13 are rotated. Resilient bushings 78, 79 are provided about each of the longitudinal axes 76, 77 to allow the grapple tooth assembly 14 and the swingable arms 12, 13 to twist and conform to uneven loads. When an uneven load is encountered, the resilient bushings 78, 79 deform at their respective pivot points to allow the swingable arms 12, 13 and grapple tooth assembly 14 to twist. A plurality of grapple teeth 80 are located along the length of the cross bar 73 and are attached to the cross bar 73 by welding, U-bolts 81, or the like.

In operation, the grapple 10 is first attached to a loader 26 by moving a coupling structure of the loader 26 into engagement with the angled mounting portion 22 on the rear side of the base frame 11. The attachment to the loader 26 is completed by moving the existing locking structure on the loader 26 into engagement with the openings 24, 25 in the angled bottom portion 23 of the base frame 11. With the grapple 10 attached to the loader 26, it can be used by itself, or it can be coupled with other loader attachments 55, such as a loader bucket or bale fork.

The grapple 10 is attached to other loader attachments 55 in the same manner as the grapple 10 is attached to the loader 26. Specifically, the upper engagement surfaces 33 of the coupling assemblies 29, 30 on the front side 31 of the base frame 11 are moved into engagement with a corresponding structure on the loader attachment 55, and the lower engagement surfaces 34 and locking pin assemblies 37 are then moved into locking engagement with corresponding openings on the loader attachment 55.

The coupling assemblies 29, 30 on the front side 31 of the base frame 11 and the angled mounting portions 22, 23 on the rear side of the base frame 11 allow the grapple 10 to be interposed between a loader 26 and a loader attachment 55 designed to couple to the loader 26 directly. The grapple 10 can thus be used with a wide variety of loader attachments 55 without modifying the attachments or the loader.

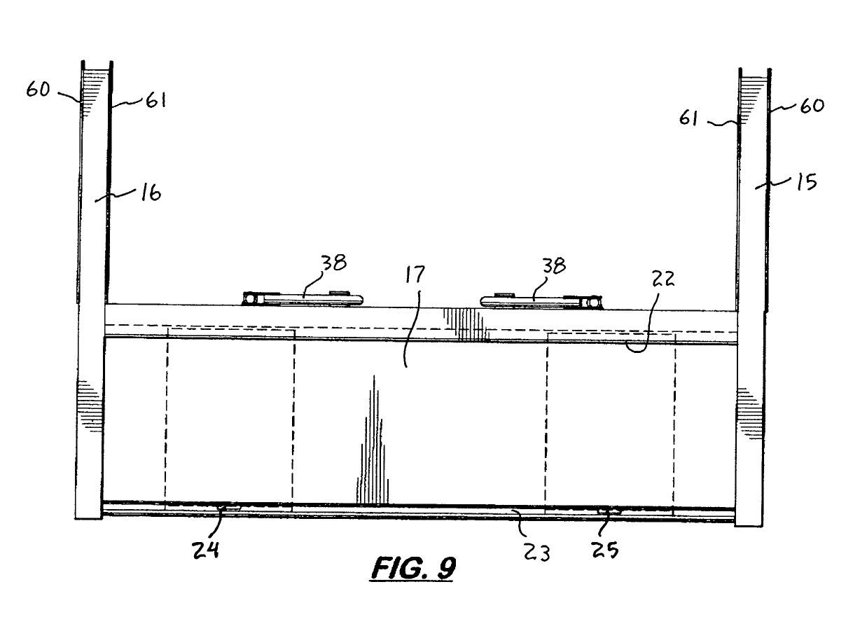

Moreover, by pivotally coupling the grapple tooth assembly 14 to the swingable arms 12, 13 using resilient bushings 78, 79, the grapple tooth assembly 14 is able to twist and conform to uneven loads, as illustrated in FIGS. 7 and 8.

It will be appreciated that certain features of the present invention have separate utility from the grapple. For example, the grapple tooth assembly 14 can be replaced with a rotating broom assembly (not shown), an asphalt cutter (not shown), a rake (not shown), or a scraper device (not shown) supported by the swingable arms 12, 13. The swingable arms 12, 13 and quick attach structures on the front and rear sides of the base frame 11 can then be used to couple the broom assembly or the like to another loader attachment, such as a loader bucket.

While the invention has been specifically described in connection with specific embodiments thereof, it is to be understood that this is by way of illustration and not of limitation, and the scope of the appended claims should be construed as broadly as the prior art will permit.

What is claimed is:

1. A grapple for use with a loader and a loader attachment, comprising:
a base frame having a front side and a rear side;
at least one swingable arm having a first end pivotally connected to said base frame and a second end supporting a grapple tooth assembly; and
a hydraulic actuator connected between said base frame and said grapple arm to swing said grapple arm relative to said base frame;
said base frame having a first coupling assembly on said rear side and a second coupling assembly on said front side, said first coupling assembly being configured for coupling with the loader, and said second coupling assembly being configured for coupling with the loader attachment.

2. The grapple as set forth in claim 1, wherein said first coupling assembly comprises upper and lower engagement surfaces which extend across the rear side of said base frame, said upper engagement surface being sloped upwardly and forwardly relative to said base frame to provide a quick coupling capability, said lower engagement surface having at least one receptacle for receiving a locking pin to secure the grapple to the loader.

3. The grapple as set forth in claim 1, wherein said second coupling assembly comprises a sloped upper engagement surface which extends upwardly and forwardly from the front side of said base frame, a lower engagement surface, and a locking pin assembly.

4. The grapple as set forth in claim 3, wherein said locking pin assembly has a locked position in which a locking pin protrudes from said lower engagement surface for locking engagement with a corresponding receptacle on the loader attachment.

5. The grapple as set forth in claim 4, wherein said locking pin assembly further comprises a lever and linkage assembly for moving said locking pin assembly between its locked and unlocked positions.

6. The grapple as set forth in claim 4, wherein said locking pin assembly comprises a first shaft pivotally mounted to said base frame for rotation about a longitudinal axis, a handle connected to a first end of said shaft, a throw arm extending from a second end of said shaft, a first linkage pivotally connected between a free end of said throw arm and an upper end of an offset linkage, said offset linkage having a lower end connected to an upper end of a locking pin and being guided for reciprocating movement by a guide structure, and a spring arranged to bias the locking pin into its locked position.

7. The grapple as set forth in claim 1, wherein said second coupling assembly comprises right and left coupling assemblies positioned on the front side of said base frame, said right and left coupling assemblies each having a sloped upper engagement surface which extends upwardly and forwardly from the front side of said base frame, a lower engagement surface, and a locking pin assembly, said locking pin assembly having a locking pin movable between a locked position in which the pin protrudes from the lower engagement surface and an unlocked position in which the pin does not protrude therefrom.

8. The grapple as set forth in claim 1, wherein said second coupling assembly comprises a locking pin assembly having a handle positioned on an upper side of said base frame which is movable to cause a locking pin at a lower side of said base frame to move between locked and unlocked positions, and further comprising a holder into which said handle can be placed to restrict movement of said handle.

9. The grapple as set forth in claim 1, wherein said second coupling assembly corresponds in size and shape to said first coupling assembly such that the grapple can be interposed between a loader and a loader attachment capable of coupling to said loader.

10. The grapple as set forth in claim 1, wherein said at least one swingable arm comprises right and left swingable arms which are pivotally attached to right and left sides of said base frame, respectively, and said grapple tooth assembly comprises a cross bar extending between the second ends of said right and left arms and grapple teeth secured to and extending from the cross bar at spaced locations along the cross bar.

11. The grapple as set forth in claim 10, wherein said right and left swingable arms are pivotally connected to said base frame about respective transverse axes, and said right and left sides of said cross bar are pivotally coupled to the second ends of said swingable arms about respective axes which are generally perpendicular to said transverse axes.

12. The grapple as set forth in claim 10, wherein said right and left sides of said cross bar are pivotally coupled to the second ends of said swingable arms using resilient bushings that allow the cross bar and swingable arms to twist and conform to uneven loads.

13. The grapple as set forth in claim 10, wherein said right and left swingable arms have telescoping constructions that are adjustable to change a length thereof.

14. In combination, a loader, a first loader attachment, and a second loader attachment, the first and second loader attachments each having a coupling assembly configured for attaching to a corresponding structure on said loader such that said first and second loader attachments are interchangeable, said first loader attachment further comprising:
a base frame having a front side and a rear side;
at least one swingable arm having a first end pivotally connected to said base frame and a second end supporting a tool; and
a hydraulic actuator connected between said base frame and said swingable arm to swing said swingable arm relative to said base frame;
said base frame having a first coupling assembly on said rear side and a second coupling assembly on said front side, said first coupling assembly being configured to couple with said corresponding structure on said loader, and said second coupling assembly being configured to couple with said coupling assembly of said second loader attachment, whereby said second loader attachment can be coupled to and used with said first loader attachment after said first loader attachment is coupled to said loader.

15. The combination as set forth in claim 14, wherein said first loader attachment is a grapple and said tool supported on said swingable arm is a grapple tooth assembly.

16. The combination as set forth in claim 14, wherein said second loader attachment is a loader bucket.

17. The combination as set forth in claim 14, wherein said second loader attachment is a bale fork.

18. The combination as set forth in claim 14, wherein said second coupling assembly corresponds in size and shape to said first coupling assembly such that the first loader attachment can be interposed between the loader and any loader attachment capable of coupling to said loader.

19. A loader attachment for use with a loader, comprising:
a base frame;
a pair of swingable arms each having a first end pivotally connected to said base frame about a transverse axis, and a second end; and
a tool having right and left sides which are connected to the respective second ends of said swingable arms;
said right and left sides of said tool being pivotally coupled to the second ends of said swingable arms using resilient bushings that allow the tool and swingable arms to twist and conform to uneven loads.

20. The loader attachment as set forth in claim 19, wherein said loader attachment is a grapple, and said tool comprises a cross bar and a plurality of grapple teeth secured to and extending from the cross bar at spaced locations along the cross bar.

21. The loader attachment as set forth in claim 19, wherein said right and left sides of said tool are pivotally coupled to the second ends of said swingable arms about respective axes which are generally perpendicular to said transverse axis.

22. The loader attachment as set forth in claim 21, wherein said respective axes are generally parallel and laterally offset relative to each other.

23. The loader attachment as set forth in claim 19, further comprising a first hydraulic actuator connected between said base frame and a first one of said swingable arms, and a second hydraulic actuator connected between said base frame and a second one of said swingable arms, said hydraulic actuators being operable to pivot said swingable arms relative to said base frame.
